(19) United States
(12) Patent Application Publication
(10) Pub. No.: US 2011/0116462 A1
(43) Pub. Date: May 19, 2011

(54) APPARATUS AND METHOD FOR TRANSMITTING AND RECEIVING REFERENCE LOCATION SIGNAL IN MOBILE COMMUNICATION SYSTEM

(75) Inventors: Lei ZHOU, Beijing (CN); Sang-Heon KIM, Suwon-si (KR); Hee-Won KANG, Seongnam-si (KR); Fangmin XU, Beijing (CN)

(73) Assignee: SAMSUNG ELECTRONICS CO. LTD., Suwon-si (KR)

(21) Appl. No.: 12/946,123

(22) Filed: Nov. 15, 2010

(30) Foreign Application Priority Data
Nov. 13, 2009 (CN) 200910206451.X

(51) Int. Cl. H04W 72/04; H04W 4/02

(52) U.S. Cl. 370/329; 455/456.3

(57) ABSTRACT

A method and an apparatus for transmitting/receiving a reference signal in a mobile communication system are provided. The method of a base station includes determining a cell identifier of a plurality of segments included in the base station, determining a resource allocated to the plurality of segments using the cell identifier in a preconfigured Location Based Service (LBS) zone, and transmitting a reference location beacon signal via the determined resource. The plurality of segments is allocated the same resource, and transmits the same signal. Therefore, accuracy of location estimation may be guaranteed.

### PRIORITY

This application claims the benefit under 35 U.S.C. §119(a) of a China patent application filed on Nov. 13, 2009 in the China Intellectual Property Office and assigned Serial No. 200910206451.x, the entire disclosure of which is hereby incorporated by reference

### BACKGROUND OF THE INVENTION

1. Field of the Invention

The present invention relates to mobile communication technologies. More particularly, the present invention relates to an apparatus and a method for transmitting and receiving a reference location beacon signal.

2. Description of the Related Art

Radio location technology is widely applied to an automatic vehicle location system, a public transport field, a taxi scheduling field and a police tracing field. In view of more requirements for location based information services, research on the radio location technology has increased.

In a usual cellular mobile communication network, a usual radio location method is a Time Difference Of Arrival (TDOA) method, i.e., a Mobile Station (MS) determines a location of the MS by detecting a difference between time points that signals of two cells reaches in the MS. In the TDOA method, the MS needs to use signals of at least three cells to determine the location and does not need to learn a specific time of signal transmission, and by the TDOA method, a common error caused by channels can be eliminated or decreased. However, signals of a serving cell are stronger than signals of adjacent cells. Therefore, the signals of the adjacent cells will be interfered by the strong signals of the serving cell resulting in a larger measurement error, which is a famous hearing problem. In an Enhanced 911 (E911), it is required that in a cell location errors within 50 meters reach 67% and location errors within 150 meters reach 95%. FIG. 1 is a schematic diagram illustrating a location error curve of a conventional TDOA method. The conventional TDOA method cannot meet location requirements of the E911.

In order to solve the above hearing problem, a method for establishing a Location Based Service (LBS) zone is provided. In the method, a first subframe of a frame is provided as an LBS zone to transmit reference location beacon signals (hereinafter referred to as “reference signals”) of adjacent cells, i.e., all time-frequency resources of the subframe are used to transmit the reference signals of the adjacent cells, and the MS performs location measurement by using the reference signals of the adjacent signals in the LBS zone. The method may effectively restrain interference of signals of the serving cell to the signals of adjacent cells and improve a location precision. However, a downlink data receiving response (ACKnowledgement (ACK) or a Non-ACKnowledgement (NACK)) cannot be transmitted in the subframe, which will seriously affect a timing synchronization of Hybrid Automatic Repeat reQuest (HARQ).

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for transmitting and receiving a reference location beacon signal, to guarantee precision of location measurement and meet timing synchronization requirements of Hybrid Automatic Repeat reQuest (HARQ).

Another aspect of the present invention is to provide an apparatus and a method for allocating a resource for a reference location beacon signal for a cell including a plurality of segments in a mobile communication system.

Still another aspect of the present invention is to provide an apparatus and a method for allocating the same resource for reference location beacon signals of a plurality of segments included in one cell in a mobile communication system.

In accordance with an aspect of the present invention, a method of a base station, for transmitting a reference location beacon signal in a mobile communication system is provided. The method includes determining a cell identifier of a plurality of segments included in the base station, determining a resource allocated to the plurality of segments using the cell identifier in a preset Location Based Service (LBS) zone, and transmitting a reference location beacon signal via the determined resource, the plurality of segments being allocated the same resource and transmitting the same signal.

In accordance with another aspect of the present invention, a method of a terminal, for receiving a reference location beacon signal in a mobile communication system is provided. The method includes determining a cell identifier of a plurality of segments included in at least two base stations in which signals are received, determining a resource allocated to the plurality of segments included in each of the at least two base stations using the cell identifier in a preset Location Based Service (LBS) zone, and receiving a reference location beacon signal from the at least two base stations via the determined resource, the plurality of segments being allocated the same resource and transmitting the same signal.

In accordance with still another aspect of the present invention, an apparatus of a base station, for transmitting a reference location beacon signal in a mobile communication system is provided. The apparatus includes a controller for determining a cell identifier of a plurality of segments included in the base station, and determining a resource allocated to the plurality of segments using the cell identifier in a preset Location Based Service (LBS) zone, and a transmitter for transmitting a reference location beacon signal to a terminal via the determined resource, the plurality of segments being allocated the same resource and transmitting the same signal.

In accordance with yet another aspect of the present invention, an apparatus of a terminal, for receiving a reference location beacon signal in a mobile communication system is provided. The apparatus includes a controller for determining a cell identifier of a plurality of segments included in at least two base stations in which signals are received, and determining a resource allocated to the plurality of segments included in each of the at least two base stations using the cell identifier in a preset Location Based Service (LBS) zone, and a receiver for receiving a reference location beacon signal from the at least two base stations via the determined resource, the plurality of segments being allocated the same resource and transmitting the same signal.

In the above described technical schemes, time-frequency resources corresponding to a preset frequency band occupied by all Orthogonal Frequency Division Multiplexing (OFDM) symbols in a downlink subframe of a super frame are provided as an LBS zone, so that time-frequency resources corresponding to other frequency bands in the downlink subframe are used to transmit control signals and data signals, or time-frequency resources occupied by part of the OFDM symbols in at least two downlink subframes of a super frame are provided as an LBS zone, so that time-frequency resources occupied by other OFDM symbols in the at least two downlink subframes are used to transmit the control signals and the data signals, and indicating information containing information of a supper frame in which the LBS zone is located is transmitted to the MS. Accordingly, when the reference signals of adjacent cells are transmitted in the LBS zone, precision of a location measurement may be guaranteed, and the transmission of data signals including an ACKnowledgement (ACK) or a Non-ACKnowledgement (NACK) in the subframe may be guaranteed to meet timing synchronization requirements of the HARQ.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

FIG. 1 is a schematic diagram illustrating a location error curve of a Time Difference Of Arrival (TDOA) method according to the related art.

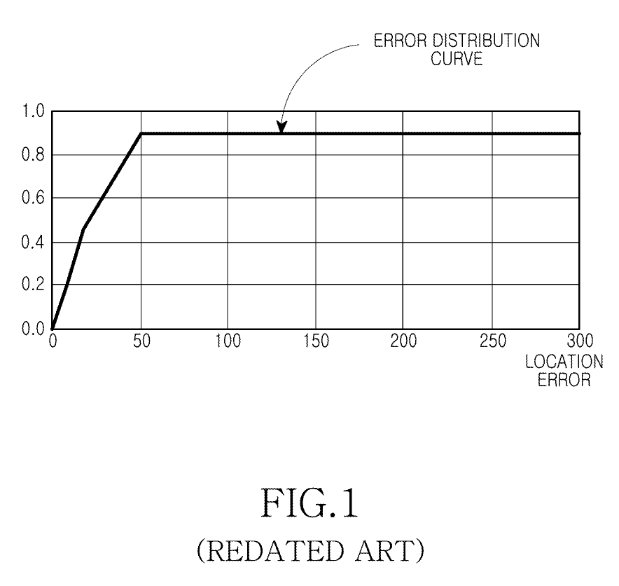

FIG. 2 is a schematic diagram illustrating a Location Based Service (LBS) zone in a centralized mode according to an exemplary embodiment of the present invention.

FIG. 3 is a schematic diagram illustrating a Physical Resource Unit (PRU) of an LBS zone in a centralized mode according to an exemplary embodiment of the present invention.

FIG. 4 is a schematic diagram illustrating a PRU of an LBS zone in a centralized mode according to an exemplary embodiment of the present invention.

FIG. 5 is a schematic diagram illustrating an LBS zone in a distributed mode according to an exemplary embodiment of the present invention.

FIG. 6 is a schematic diagram of allocating resources to reference signals of adjacent cells by using a Frequency Division Multiplexing (FDM) mode in a distributed mode according to an exemplary embodiment of the present invention.

FIG. 7 is a schematic diagram illustrating a reference signal sequence corresponding to a resource allocating mode according to an exemplary embodiment of the present invention.

FIG. 8 is a schematic diagram of allocating resources to reference signals of adjacent cells by using a combination mode of an FDM mode and a Time Division Multiplexing (TDM) mode in a distributed mode according to an exemplary embodiment of the present invention.

FIG. 9 is a schematic diagram of allocating resources to reference signals of adjacent cells by using an FDM mode and a TDM mode in a distributed mode according to an exemplary embodiment of the present invention.

FIG. 10 is a schematic diagram illustrating a reference signal sequence corresponding to a resource allocating mode according to an exemplary embodiment of the present invention.

FIG. 11 is a schematic diagram illustrating an LBS zone in a distributed mode according to an exemplary embodiment of the present invention.

FIG. 12 is a schematic diagram of allocating resources to reference signals of adjacent cells according to an exemplary embodiment of the present invention.

FIG. 13 is a flowchart illustrating a procedure for transmitting a reference signal at a base station according to an exemplary embodiment of the present invention.

FIG. 14 is a flowchart illustrating a procedure for receiving a reference signal at a terminal according to an exemplary embodiment of the present invention.

FIG. 15 is a schematic block diagram illustrating a base station according to an exemplary embodiment of the present invention.

FIG. 16 is a schematic block diagram illustrating a terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide time-frequency resources corresponding to a preset frequency band occupied by all Orthogonal Frequency Division Multiplexing (OFDM) symbols in a downlink subframe of a super frame that are provided as a Location Based Service (LBS) zone, or time-frequency resources occupied by part of the OFDM symbols in at least two downlink subframes of a super frame that are provided as an LBS zone, a serving base station that transmits an MS indicating information containing information of a super frame in which an LBS zone is located, and base stations of adjacent cells transmit reference signals to the MS.

The reference signals of the adjacent cells are transmitted on the LBS zone by using a Time Division Multiplexing (TDM) mode, a Frequency Division Multiplexing (FDM) mode or a combination mode of the TDM mode and the FDM mode.

Correspondingly, the MS receives indicating information containing information of a super frame in which an LBS zone is located from a serving cell, and the reference signals of the adjacent cells on the LBS zone according to the indicating information to perform the location measurement of the MS. The MBS zone is time-frequency resources corresponding to a preset frequency band occupied by all OFDM symbols in a downlink subframe of a super frame, or time-frequency resources occupied by part of the OFDM symbols in at least two downlink subframes of a super frame.

The MS receives the reference signals of the adjacent cells on the LBS zone by using the TDM mode, the FDM mode or the combination mode of the TDM mode and the FDM mode.

In an exemplary implementation, configuration modes of the LBS zone include a centralized mode and a distributed mode. In the centralized mode, the LBS zone is configured in a subframe of a super frame, and in the distributed mode, the LBS zone includes resources distributed according to a preset rule. For example, in the distributed mode, the LBS zone may be configured in a specific subframe within one super frame and a specific subframe within another super frame, or configured in two subframes within one super frame. In a case in the distributed mode, the LBS zone is configured in at least two subframes in one super frame and is described below for convenience.

### The Centralized Mode

In the centralized mode, the LBS zone is configured in one subframe of a super frame, the LBS zone appears in part of a frequency band of all the OFDM symbols in the subframe, and other frequency bands of the subframe may be provided as a control information zone and a data zone to transmit A-MAP control signals and data signals such as an ACK or a NACK. That is, the reference signals for location, control signals and data signals are multiplexed in the downlink subframe by using the FDM mode.

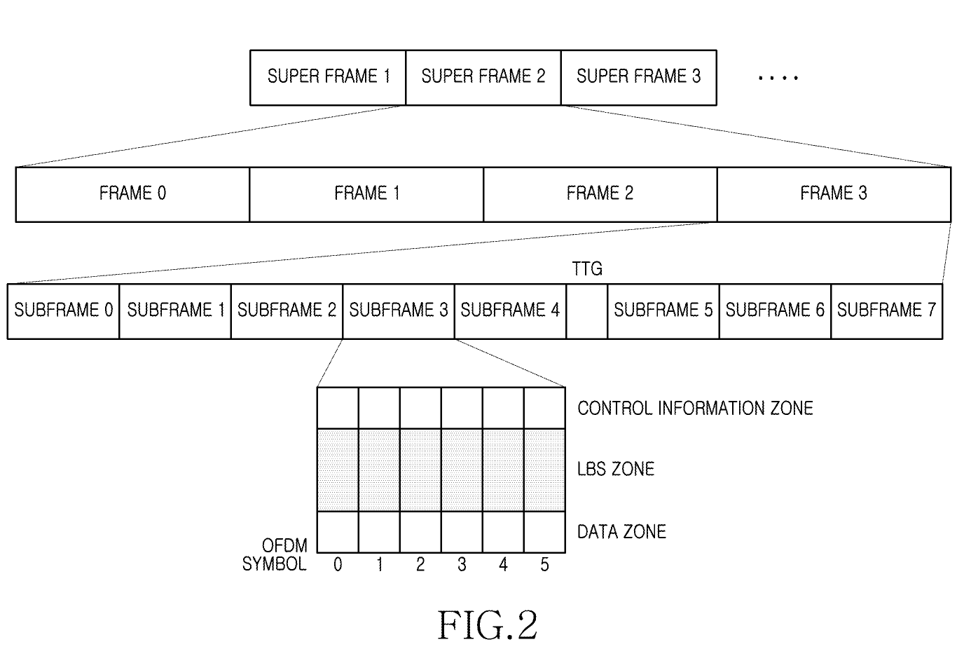

FIG. 2 is a schematic diagram illustrating a LBS zone in a centralized mode according to an exemplary embodiment of the present invention.

Referring to FIG. 2, one super frame includes four frames, and the LBS zone may be configured in a downlink subframe of any one frame. In a fourth subframe of the last frame in FIG. 2 as an example, the first to fifth subframes are downlink subframes, and the sixth to eighth subframes are uplink subframes. Time-frequency resources corresponding to a preset frequency band occupied by all 6 OFDM symbols in the fourth subframe are provided as the LBS zone (illustrated by grey zones), other frequency bands are provided as the control information zone and the data zone.

Besides the necessary time-frequency resources occupied by the control information zone and the data zone, the time-frequency resources occupied by the LBS zone only need to meet location performance requirements, e.g., when the location performance requirements of E911 are met, time-frequency resources of 144 subcarriers occupied by 6 OFDM symbols are needed.

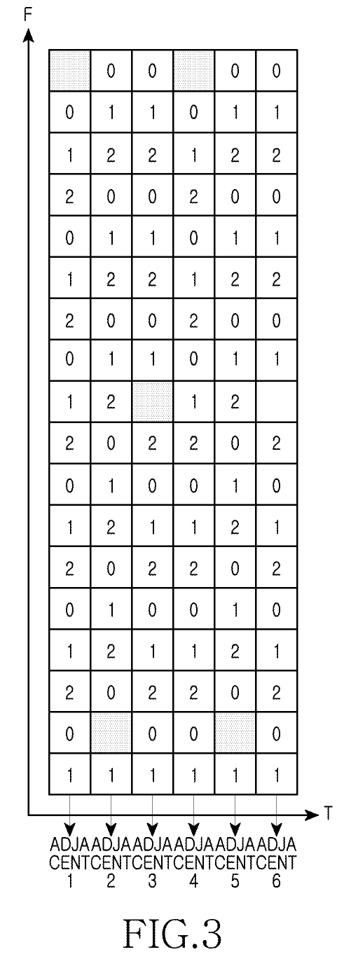

FIG. 3 is a schematic diagram illustrating a Physical Resource Unit (PRU) of an LBS zone in a centralized mode. The PRU is a minimum resource unit of a physical layer. Since a pilot signal is needed when channel estimation is performed for control signals and data signals, it is needed to reserve time-frequency resources in the LBS zone for the pilot signal. As illustrated in FIG. 3, grey zones represent time-frequency resources occupied by the pilot signal, and time-frequency resources except for time-frequency resources occupied by the pilot signal may be used to transmit reference signals. In addition, since one subframe includes 6 OFDM symbols, which may be allocated to 6 adjacent cells, i.e., the TDM mode is adopted and one OFDM symbol corresponds to one adjacent cell. As illustrated in FIG. 3, the first OFDM symbol in the LBS zone is used to transmit reference signals of the first adjacent cell, the second OFDM symbol is used to transmit reference signals of the second adjacent cell, and the remaining OFDM symbols may be deduced by analogy.

More specifically, the FDM mode may be used in each OFDM symbol to allocate resources to reference signals in different segments of each adjacent cell. In FIG. 3, for example, each adjacent cell includes 3 segments which are identified by 0, 1 and 2. Segments of each adjacent cell may not be differentiated, and the resources are allocated uniformly. In addition, different segments within each adjacent cell transmit the same signal.

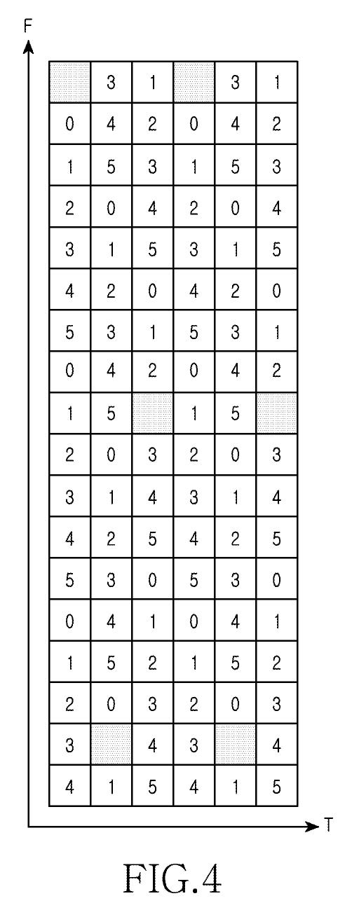

FIG. 3 illustrates a case of allocating resources to reference signals of adjacent cells by using the TDM mode, the resources may also be allocated by using the FDM mode, as illustrated in FIG. 4.

FIG. 4 is a schematic diagram illustrating a PRU of an LBS zone in a centralized mode according to an exemplary embodiment of the present invention.

Referring to FIG. 4, each OFDM symbol in the LSB zone is allocated to the adjacent cells synchronously, and the reference signals of adjacent cells are differentiated on each OFDM symbol by using the FDM mode. In FIG. 4, 0, 1, 2, 3, 4, 5 and 6 respectively identify resources allocated to reference signals of 6 adjacent cells, and grey zones represent time-frequency resources occupied by a pilot signal.

When the FDM mode is used, time-frequency resources of at least two adjacent OFDM symbols on the same frequency are allocated to different adjacent cells, to improve randomization and the anti-interference capability. As illustrated in FIG. 4, a second resource block of a first OFDM symbol is allocated to the first adjacent cell (identified by 0), a second resource block of the second OFDM symbol is allocated to the fifth adjacent cell (identified by 4), and a second resource block of a third OFDM symbol is allocated to a third adjacent cell (identified by 2).

When identifiers are allocated to the adjacent cells, equation 1 may be adopted as follows:

IDcell_{RSi}=256·n+Idx_{RSi} (1)

In equation 1, RSi represents an iₜₕ reference signal, i=0, 1, . . . N−1; N is a number of reference signals to be supported, n is a number of segments of a cell, IDcell_{RSi} is an identifier of a cell corresponding to an iₜₕ reference signal, and Idx_{RSi} represents indexes of RSi in [i:N:255]. In order to determine an ID of a cell, Idx_{RSi} is increased by multiples of N from i to 255.

In a centralized mode, an MS may receives reference signals of one adjacent cell on time-frequency resources occupied by each OFDM symbol in a LBS zone, and different OFDM symbols correspond to different adjacent cells, or receives reference signals of all adjacent cells on time-frequency resources occupied by each OFDM symbol in the LBS zone, and receives reference signals of different adjacent cells on time-frequency resources of at least two adjacent OFDM symbols on the same frequency.

### The Distributed Mode

In the distributed mode, the LBS zone is configured in at least two downlink subframes of a super frame, the LBS zone only appears in part of the OFDM symbols of the at least two downlink subframes, and other OFDM symbols may be still provided as a control information zone and a data zone. That is, the LBS zone, the control information zone and the data zone are multiplexed in the at least two downlink subframes by using the FDM mode.

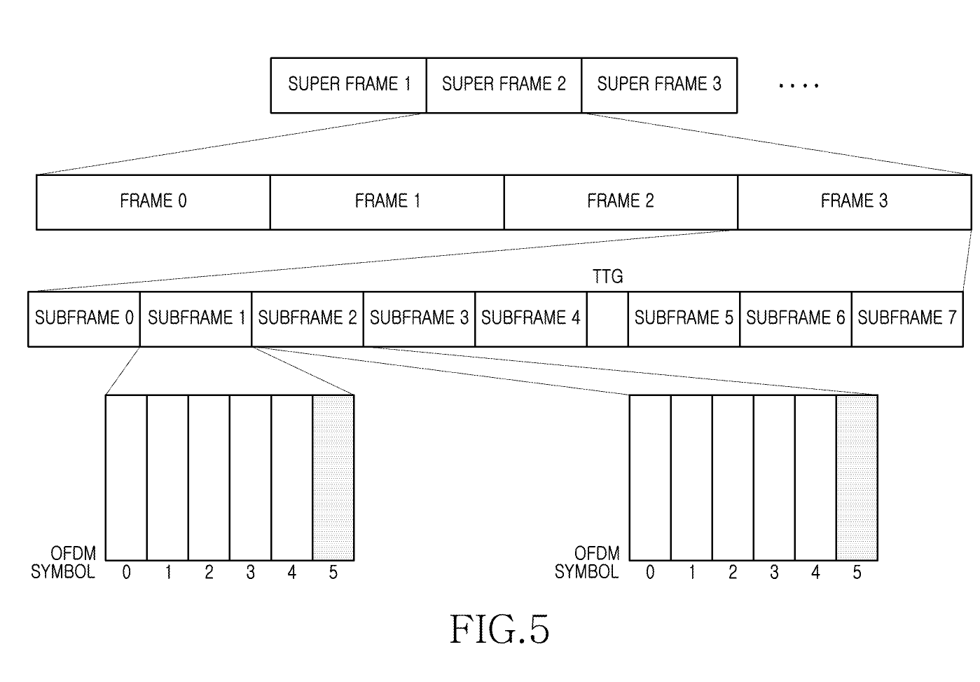

FIG. 5 is a schematic diagram illustrating an LBS zone in a distributed mode according to an exemplary embodiment of the present invention.

Referring to FIG. 5, two OFDM symbols in second and third subframes of a last frame in a super frame are configured as the LBS zone. Other modes may be used, e.g., part of the OFDM symbols in part of subframes of the second frame are configured as the LBS zone, or N OFDM symbols in part of subframes of a frame are configured as the LBS zone, where 1≦N<6. Here, FIG. 5 is provided as an example.

As illustrated in FIG. 5, time-frequency resources occupied by the last OFDM symbols in the second and third subframes of the last frame constitute the LBS zone (illustrated by grey zones), and the time-frequency resources occupied by other OFDM symbols are still provided as a control information zone and a data zone, to guarantee the transmission of an ACK or a NACK in the second and the third subframes.

In the LBS zone, resources may be allocated to the reference signals of adjacent cells by using an FDM mode or a combination mode of a TDM mode and the FDM mode, which will be in more detail below.

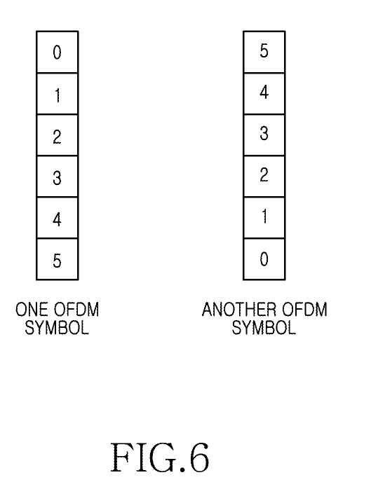

FIG. 6 is a schematic diagram of allocating resources to reference signals of adjacent cells by using an FDM mode according to an exemplary embodiment of the present invention.

Referring to FIG. 6, in an LBS zone constituted by last OFDM symbols of second and third subframes, 6 adjacent cells multiplex resources on each OFDM symbol by using the FDM mode, i.e., each OFDM symbol bears reference signals of 6 adjacent cells.

Similarly, time-frequency resources of at least two adjacent OFDM symbols in the LBS zone on the same frequency are allocated to different adjacent cells, to improve randomization and an anti-interference capability. As illustrated in FIG. 6, a first resource block of the last OFDM symbol in the second subframe is allocated to the first adjacent cell (identified by 0), and the first resource block of the last OFDM symbol in the third subframe is allocated to the sixth adjacent cell (identified by 5). In FIG. 6, two OFDM symbols constitute the LBS zone, if more OFDM symbols constitute the LBS zone, e.g., one OFDM symbol is selected respectively from four subframes to constitute the LBS zone, time-frequency resources may be allocated to the reference signal of 6 adjacent cells on each OFDM symbol by using the FDM mode, and time-frequency resources of at least two adjacent OFDM symbols are allocated to different adjacent cells.

In the resource allocating mode illustrated in FIG. 6, when base stations of adjacent cells transmit reference signals of respective adjacent cells, the base stations may transmit reference signals having sequence length corresponding to specific bandwidth.

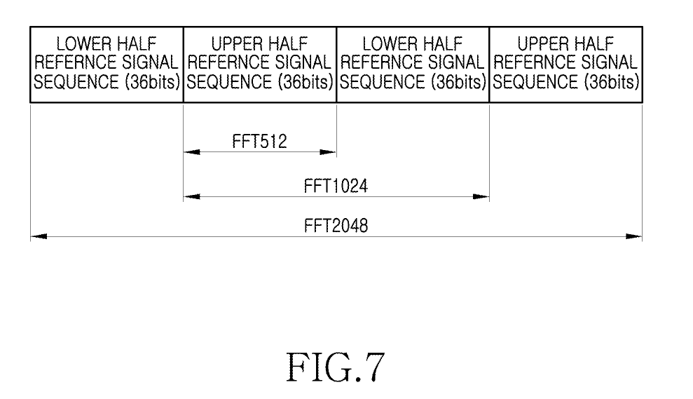

FIG. 7 is a schematic diagram illustrating a reference signal sequence corresponding to a resource allocating mode according to an exemplary embodiment of the present invention.

Referring to FIG. 7, when the length of Fast Fourier Transformation (FFT) which is allowed by the bandwidth allocated to a certain adjacent cell is 1024, a sequence length may be 72 bits. If the length of 1024 is provided as a unit, when the length of the FFT which is allowed by the bandwidth allocated to a certain adjacent cell is 2048, the sequence length is 144 bits. At this time, a reference signal sequence may be constituted as having the length of 1024 that is divided into an upper half (36 bits) and a lower half (36 bits), two reference signal sequences having the length of 1024 that are repeated, an orthogonal mode that is adopted when the two reference signal sequences are arranged, i.e., the upper half is adjacent with the lower half, to avoid the upper half being adjacent with another upper half and the lower half being adjacent with another lower half. When the length of FFT which is allowed by the bandwidth allocated to a certain adjacent cell is 512, the sequence length is 36 bits. At this time, only one of the upper half and lower half of the reference signal sequence having the length of 1024 may be selected.

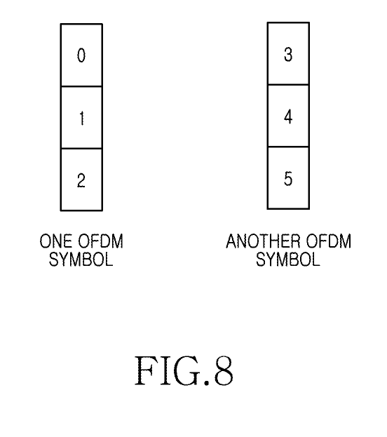

FIG. 8 is a schematic diagram of allocating resources to reference signals of adjacent cells by using a combination mode of an FDM mode and a TDM mode in a distributed mode according to an exemplary embodiment of the present invention.

Referring to FIG. 8, on the last OFDM symbol of the second subframe, resources are allocated to reference signals of first to third adjacent cells which are identified by 0, 1 and 2 by using the FDM mode. On the last OFDM symbol of the third subframe, resources are allocated to reference signals of fourth to sixth adjacent cells which are identified by 3, 4 and 5 by using the FDM mode

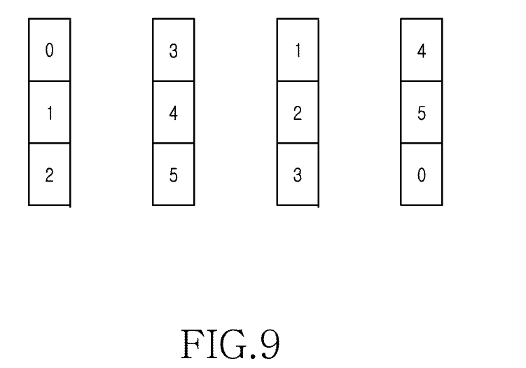

In FIG. 8, two OFDM symbols constitute an LBS zone, if more OFDM symbols constitute the LBS zone, e.g., one OFDM symbol is selected respectively from four subframes to constitute the LBS zone, resources may be allocated by using a combination mode of the FDM mode and the TDM mode, as illustrated in FIG. 9.

FIG. 9 is a schematic diagram of allocating resources to reference signals of adjacent cells by using an FDM mode and a TDM mode in a distributed mode according to an exemplary embodiment of the present invention.

Referring back to FIG. 8, in order to improve randomization and an anti-interference capability, time-frequency resources of at least two adjacent OFDM symbols on the same frequency are allocated to different adjacent cells.

When identifiers (i.e., CellIDs) are allocated to the adjacent cells, equation 2 may be adopted as follows:

IDcell_{RSi}=256·n+Idx_{RSi} (2)

In equation 2, RSi represents an iₜₕ reference signal, i=0, 1, . . . N−1, N is a number of reference signals to be supported, n is a number of segments of a cell, IDcell_{RSi} is an identifier of a cell corresponding to the iₜₕ reference signal, and Idx_{RSi} represents indexes of RSi in [i:N:255]. In order to determine an ID of a cell, Idx_{RSi} is increased by multiples of N from i to 255.

In a distributed mode, the MS may receive reference signals of all adjacent cells on time-frequency resources occupied by each OFDM symbol in the LBS zone, and receives reference signals of different adjacent cells on time-frequency resources of at least two adjacent OFDM symbols on the same frequency, or receives reference signals of one part of the adjacent cells on time-frequency resources occupied by one part of the OFDM symbols in the LBS zone, receives reference signals of another part of adjacent cells on time-frequency resources occupied by the other part of the OFDM symbols in the LBS zone, and receives reference signals of different adjacent cells on time-frequency resources of at least two adjacent OFDM symbols on the same frequency.

In the resource allocating mode illustrated in FIG. 8, when the base stations of adjacent cells transmit reference signals of respective adjacent cells, the base stations may transmit reference signals having sequence length corresponding to specific bandwidth.

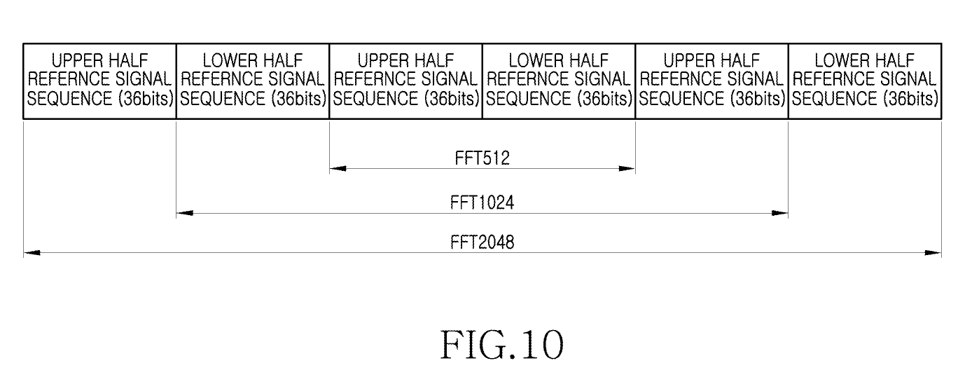

FIG. 10 is a schematic diagram illustrating a reference signal sequence corresponding to a resource allocating mode according to an exemplary embodiment of the present invention.

Referring to FIG. 10, since the bandwidth allocated to the adjacent cells in the resource allocating mode as illustrated in FIG. 8 is one time larger than that in the resource allocating mode as illustrated in FIG. 6, when the length of a FFT which is allowed by the bandwidth allocated to a certain adjacent cell is 512, the sequence length may be 72 bits. When the length of the FFT which is allowed by the bandwidth allocated to a certain adjacent cell is 1024, the sequence length is 144 bits. At this time, a reference signal sequence may be constituted as having the length of 512 that is divided into an upper half (36 bits) and a lower half (36 bits), two reference signal sequences having the length of 512 that are repeated, an orthogonal mode that is adopted when the two reference signal sequences are arranged, i.e., the upper half is adjacent with the lower half, to avoid the upper half being adjacent with another upper half and the lower half being adjacent with another lower half. When the length of the FFT which is allowed by the bandwidth allocated to a certain adjacent cell is 2048, the reference signal sequence having the length of 512 is provided as a unit, and the orthogonal mode is adopted when the two reference signal sequences are arranged. Reference signal sequences having other lengths may be deduced by analogy.

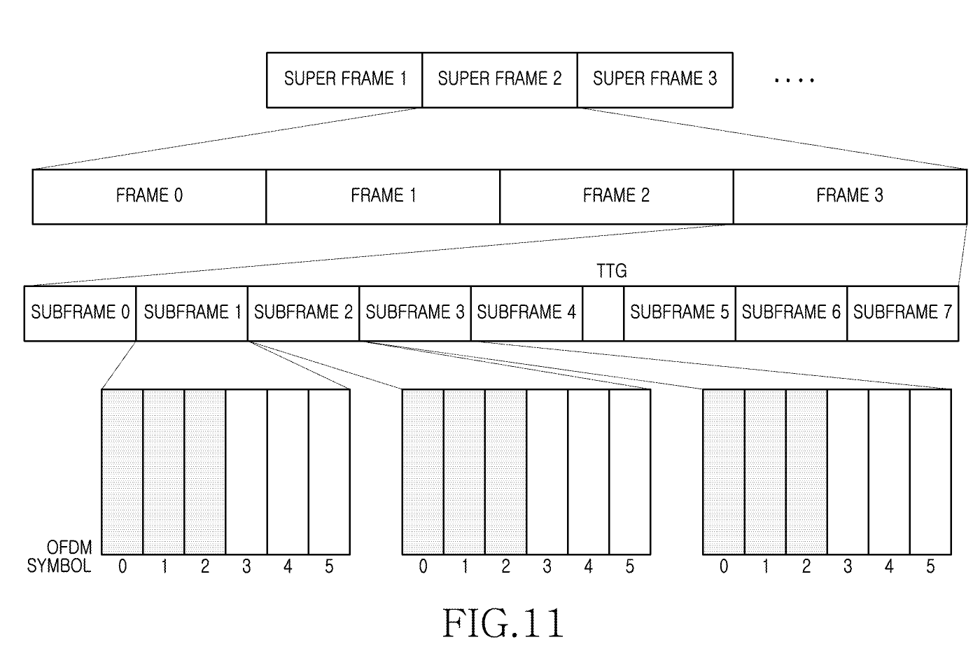

FIG. 11 is a schematic diagram illustrating an LBS zone in a distributed mode according to an exemplary embodiment of the present invention.

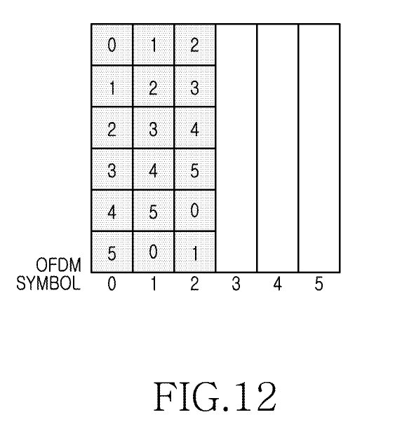

Referring to FIG. 11, in the distributed mode, for example, time-frequency resources occupied by 3 OFDM symbols respectively in the second, third and fourth subframes of the last frame in a super frame are provided as the LBS zone, i.e., there are 9 OFDM symbols which are provided as the LBS zone (illustrated by grey zones in FIG. 11). Resources are allocated to reference signals of 6 adjacent cells on each OFDM symbol by using the FDM mode, and time-frequency resources of at least two adjacent OFDM symbols on the same frequency are allocated to different adjacent cells, to improve randomization and the anti-interference capability, as illustrated in FIG. 12.

FIG. 12 is a schematic diagram of allocating resources to reference signals of adjacent cells according to an exemplary embodiment of the present invention.

Referring to FIG. 12, in one subframe in which the LBS zone appears, for example, time-frequency resources occupied by the first to third OFDM symbols are configured as the LBS zone, time-frequency resources occupied by the fourth to sixth OFDM symbols may be provided as a control information zone and a data zone. The numerals in resource blocks illustrated in FIG. 11 represent resources that are allocated to different adjacent cells.

In the distributed mode, since the LBS zone occupies entire bandwidth resources which are part of the OFDM symbols in the subframe and resources occupied by other OFDM symbols are used to transmit control signals and data signals, pilot signals for performing channel estimation for the control signals and the data signals may not appear in the LBS zone. In order to achieve a better channel estimation effect, the pilot signals may also appear in the LBS zone. At this time, time-frequency resources in the LBS zone, except for time-frequency resources occupied by the pilot signals, are used to transmit the reference signals. Correspondingly, an MS may receive the reference signals of the adjacent cells on the time-frequency resources in the LBS zone or on the time-frequency resources in the LBS zone, except for the time-frequency resources occupied by the pilot signals.

Regardless if the centralized mode or the distributed mode is used, the base stations of adjacent cells transmit the reference signals of the adjacent cells on the time-frequency resources in the LBS zone, except for the time-frequency occupied by the pilot signals. A serving base station transmits to the MS the indicating information containing information of a super frame including the LBS zone, so that the MS may receive the reference signals transmitted by the base stations of the adjacent cells in the LBS zone to perform location measurement. The indicting information may be carried in a System Configuration Description (SCD) signaling, a sub-packet unit of a super frame head or a location request signaling, which will be described in detail below.

1) When the indicating information is carried in a SCD signaling, the carried indicating information may be information as shown in Table 1 that indicates whether a super frame includes the LBS zone (LBS-Zone indicator), a configuration mode of the LBS zone (LBS-Zone mode), a start super frame in the LBS zone (Start Super frame number), duration corresponding to the configuration mode of the LBS zone (LBS-Zone duration), and period information of the LBS zone (LBS-Zone period).

The LBS-Zone indicator indicates whether the super frame includes the LBS zone. If the LBS-Zone indicator is configured as 0, the super frame does not include the LBS zone. Also, all the super frames do not include the LBS zone. If the LBS-Zone indicator is configured as 1, the super frame includes the LBS zone.

The LBS-Zone mode indicates the configuration mode of the LBS zone, and includes a once mode, a continuous mode and a period mode. When the LBS-Zone mode is the once mode, the LBS zone only appears in one super frame. When the LBS-Zone mode is the continuous mode, the LBS zone continuously appears in each super frame from a super frame indicated by Start Super frame number. When the LBS-Zone mode is the period mode, the LBS zone periodically appears in super frames from the super frame indicated by Start Super frame number according to the period indicated by the LBS-Zone period.

The Start Super frame number indicates which super frame that the LBS zone starts to appear.

The LBS-Zone duration indicates duration of the configuration mode of the LBS zone, e.g., the LBS-Zone duration indicates that the duration of the configuration mode of the LBS zone is N super frames. If the LBS-Zone mode indicates “once”, the LBS zone only appears once in the N super frames. If the LBS-Zone mode indicates “continuous”, the LBS zone appears in each super frame. If the LBS-Zone mode indicates “period”, the LBS zone periodically appears in the N super frames according to the indication of the LBS-Zone period.

When the LBS-Zone period indicates that the configuration mode of the LBS zone is “period”, the LBS zone appears in a period of several super frames.

It should be understood that, the indicating information as shown in Table 1 is only an exemplary implementation. The indicating information may only include part of contents in Table 1, or further include other contents. For example, if the LBS-Zone mode is the once mode or the continuous mode, the indicating information may not include the LBS-Zone period, and the LBS-Zone duration is not necessary, e.g., the MS performs an operation according to the indication of the LBS-Zone mode when receiving the indicating information, until the MS receives indicating information containing a different LBS-Zone mode again.

TABLE 1

| indicating information | length | description |
|---|---|---|
| format of SCD { | | there is indicating information of |
| | | super frame including LBS zone |
| | | in super frame |
| LBS-Zone indicator | 1 | 0: not include LBS zone |
| | | 1: include LBS zone |
| if LBS-Zone indicator is | | |
| equal to 1 { | | |
| LBS-Zone mode | 2 | 00: period |
| | | 01: continuous |
| | | 10: once |
| Start Super frame number | 8 | LBS zone starts to appear from |
| | | which super frame |
| LBS-Zone duration | 8 | duration of the above |
| | | LBS-Zone mode |
| LBS-Zone period | 8 | appearing period of LBS zone |
| } | | |

If the above indicating information does not include the LBS Zone mode, the indicating information may be represented in the form of a generic function as follows:

```
E-LBS-ZONE_Parameters::= SEQUENCE {
  LBS_zone-ON INTEGER (0..1) OPTIONAL
  LBS_subframe_position INTEGER (0..7) OPTIONAL
  LBS_symbol_position INTEGER (0..7) OPTIONAL
  LBS_zone_start_superframe_numberINTEGER(0..255)
    OPTIONAL
  LBS_zone_duration INTEGER (0..255) OPTIONAL
  LBS_zone_Period INTEGER (0..255) OPTIONAL
}
```

2) When the indicating information is carried in a sub-packet unit of a super frame head, e.g., the indicating information is carried in the second sub-packet of the super frame head (PS2), the carried indicating information may be as shown in Table 2 and includes information indicating whether the current super frame includes the LBS zone (LBS-Zone indicator).

The LBS-Zone indicator indicates whether the current super frame includes the LBS zone. If the LBS-Zone indicator is configured as 0, the current super frame does not include the LBS zone. If the LBS-Zone indicator is configured as 1, the current super frame includes the LBS zone.

TABLE 2

| indicating information | length | description |
|---|---|---|
| format of supper frame | | there is indicating formation of super |
| head SP2 { | | frame including LBS zone in current |
| | | super frame |
| LBS-Zone indicator | 1 | 0: not include LBS zone |
| | | 1: include LBS zone |

3) When the indicating information is carried in the location request signaling, the carried indicating information is the same as that carried in the SCD signaling.

In the above described three transmission modes of indicating information, the location of the LBS zone in the super frame is preconfigured, i.e., the base stations of adjacent cells and the MS transmit the reference signals of the adjacent cells according to the preconfigured location of the LBS zone. If the LBS zone is configured in real time, the above indicating information may further include location information of the LBS zone, that is, the indicating information carried in the SCD signaling, the super frame head or the location request signaling may further include the location formation of the LBS zone, which specifically includes information of a frame in which the LBS zone is located (LBS_frame_position), information of a subframe in which the LBS zone is located (LBS_subframe_position) and information of an OFDM symbol in which the LBS zone is located (LBS_symbol_position). At this time, the carried indicating information in the first transmission mode and the third transmission mode is illustrated in FIG. 3, and the carried indicating information in the second transmission mode is illustrated in FIG. 4.

TABLE 3

| indicating information | length | description |
|---|---|---|
| format of SCD { | | there is indicating information of |
| | | super frame including LBS zone |
| | | in super frame |
| LBS-Zone indicator | 1 | 0: not include LBS zone |
| | | 1: include LBS zone |
| if LBS-Zone indicator is | | |
| equal to 1 { | | |
| LBS_frame_position | 2 | 0000: the first frame |
| | | 0001: the second frame |
| | | 0010: the third frame |
| | | 0011: the fourth frame |
| LBS_subframe_position | 3 | 00000: the first subframe |
| | | 00001: the second subframe |
| | | 00010: the third subframe |
| | | 00011: the fourth subframe |
| | | 00100: the fifth subframe |
| | | 00101: the sixth subframe |
| LBS_symbol_position | 3 | 00000: the first OFDM symbol |
| | | 00001: the second OFDM symbol |
| | | 00010: the third OFDM symbol |
| | | 00011: the fourth OFDM symbol |
| | | 00100: the fifth OFDM symbol |
| | | 00101: the sixth OFDM symbol |
| LBS-Zone mode | 2 | 00: period |
| | | 01: continuous |
| | | 10: once |
| Start Super frame number | 8 | LBS zone starts to appear from |
| | | which super frame |
| LBS-Zone duration | 8 | duration of the above |
| | | LBS-Zone mode |
| LBS-Zone period | 8 | appearing period of LBS zone |
| } | | |

TABLE 4

| indicating information | length | description |
|---|---|---|
| format of SCD { | | there is indicating information of |
| | | super frame including LBS zone in |
| | | current super frame |
| LBS-Zone indicator | 1 | 0: not include LBS zone |
| | | 1: include LBS zone |
| LBS_frame_position | 2 | 0000: the first frame |
| | | 0001: the second frame |
| | | 0010: the third frame |
| | | 0011: the fourth frame |
| LBS_subframe_position | 3 | 00000: the first subframe |
| | | 00001: the second subframe |
| | | 00010: the third subframe |
| | | 00011: the fourth subframe |
| | | 00100: the fifth subframe |
| | | 00101: the sixth subframe |
| LBS_symbol_position | 3 | 00000: the first OFDM symbol |
| | | 00001: the second OFDM symbol |
| | | 00010: the third OFDM symbol |
| | | 00011: the fourth OFDM symbol |
| | | 00100: the fifth OFDM symbol |
| | | 00101: the sixth OFDM symbol |

It should be understood that, the indicating information shown in Tables 1 and 3 may be transmitted by using the SCD signaling and the location request signaling, and may also be transmitted by using other signaling, e.g., scanning signaling related to location, location broadcast signaling and the like.

A system that includes a serving base station and base station of adjacent cells will be described below.

The serving base station is adapted to transmit to an MS indicating information containing information of a super frame in which an LBS zone is located.

The base stations of adjacent cells are adapted to transmit reference signals for location measurement of the MS on the LBS zone to the MS.

The MBS zone is time-frequency resources corresponding to a preset frequency band occupied by all OFDM symbols in a downlink subframe of a super frame, or time-frequency resources occupied by part of the OFDM symbols in at least two downlink subframes of a super frame.

In addition, the base stations of adjacent cells are further adapted to transmit the reference signals on the LBS zone by using a TDM mode, an FDM mode or a combination mode of the TDM mode and the FDM mode.

Since there may be a pilot signal for channel estimation in a downlink subframe in which the LBS zone is located, if the reference signals are not needed to transmit the pilot signal in the LBS zone, the base stations of the adjacent cells may transmit the reference signals of the adjacent cells on all time-frequency resources of the LBS zone. If the reference signals are needed to transmit the pilot signal in the LBS zone, the base stations of the adjacent cells may transmit the reference signals of the adjacent cells on all time-frequency resources of the LBS zone except for time-frequency resources occupied by the pilot signal.

If the LBS zone is time-frequency resources corresponding to a preset frequency band occupied by all OFDM symbols in a downlink subframe of a super frame, time-frequency resources occupied by each OFDM symbol in the LBS zone are allocated to one of the adjacent cells and different OFDM symbols correspond to different adjacent cells, or time-frequency resources occupied by each OFDM symbol in the LBS zone are allocated to all adjacent cells and time-frequency resources of at least two adjacent OFDM symbols on the same frequency are allocated to different adjacent cells.

If time-frequency resources occupied by part of the OFDM symbols in at least two downlink subframes of a super frame are provided as the LBS zone, time-frequency resources occupied by each OFDM symbol in the LBS zone are allocated to all adjacent cells and time-frequency of at least two adjacent OFDM symbols on the same frequency are allocated to different adjacent cells or time-frequency resources occupied by one part of OFDM symbols in the LBS zone are allocated to one part of adjacent cells, time-frequency resources occupied by the other part of OFDM symbols in the LBS zone are allocated to the other part of adjacent cells, and time-frequency resources of at least two adjacent OFDM symbols on the same frequency are allocated to different adjacent cells.

The serving base station may transmit to the MS the indicating information containing the information of a super frame in which the LBS zone is located by carrying the indicating information in a system configuration description signaling, a sub-packet unit of a super frame head or a location request signaling.

If the indicating information is carried in the system configuration description signaling or the location request signaling, the indicating information includes information indicating whether a super frame includes the LBS zone, information of a configuration mode of the LBS zone, information of a start super frame in the LBS zone, information of a duration corresponding to the configuration mode of the LBS zone, and period information of the LBS zone.

If the indicating information is carried in the sub-packet unit of the super frame head, the indicating information includes information indicating whether a supper frame in which the super frame head is located includes the LBS zone.

The above described indicating information is used when the LBS zone is preconfigured, i.e., the base stations of the adjacent cells and the MS transmit the reference signals according to a preconfigured location of the LBS zone. If the LBS zone is configured in real time, e.g., after configuring resources of the LBS zone, an upper layer informs the serving base station and the base stations of the adjacent cells of the resource configuration of the LBS zone, and indicating information transmitted by the serving base station may also include location information of the LBS zone. More specifically, indicating information transmitted by the serving base station may include information of a frame in which the LBS zone is located, information of a subframe in which the LBS zone is located, and information of an OFDM symbol in which the LBS zone is located.

As described above, time-frequency resources corresponding to a preset frequency band occupied by all OFDM symbols in a downlink subframe of a super frame are provided as an LBS zone, so that time-frequency resources corresponding to other frequency bands in the downlink subframe are used to transmit control signals and data signals, or time-frequency resources occupied by part of the OFDM symbols in at least two downlink subframes of a super frame are provided as an LBS zone, so that time-frequency resources occupied by other OFDM symbols in the at least two downlink subframes are used to transmit the control signals and the data signals, and indicating information containing information of a supper frame in which the LBS zone is located is transmitted to the MS. Accordingly, when the reference signals of adjacent cells are transmitted in the LBS zone, precision of a location measurement may be guaranteed, and the transmission of data signals including an ACK or a NACK in the subframe may be guaranteed to meet the timing synchronization requirements of the HARQ.

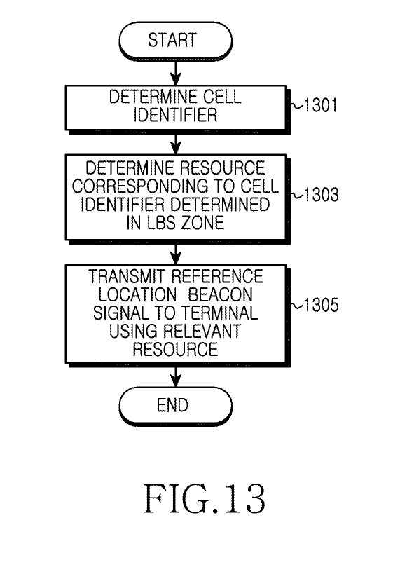

Block configurations and operation procedures of a terminal and a base station for transmitting/receiving a reference signal are described below with reference to FIGS. 13 to 16. Here, it is assumed that an LBS zone is configured in advance and the base station and the terminal know in advance information regarding the LBS zone.

FIG. 13 is a flowchart illustrating a procedure for transmitting a reference signal at a base station according to an exemplary embodiment of the present invention.

Referring to FIG. 13, the base station determines a cell identifier of the base station in step 1301. Here, when the base station has a plurality of segments, the base station may determine a cell identifier for each of the plurality of segments using equations 1 and 2.

The base station determines a time-frequency resource corresponding to the base station in an LBS zone using the determined cell identifier in step 1303. At this point, respective segments included in the base station are not discriminated but may be allocated the same resource.

The base station transmits a reference location beacon signal to a terminal using the determined time-frequency resource in step 1305. At this point, respective segments included in the base station transmit the same signal via the allocated same resource.

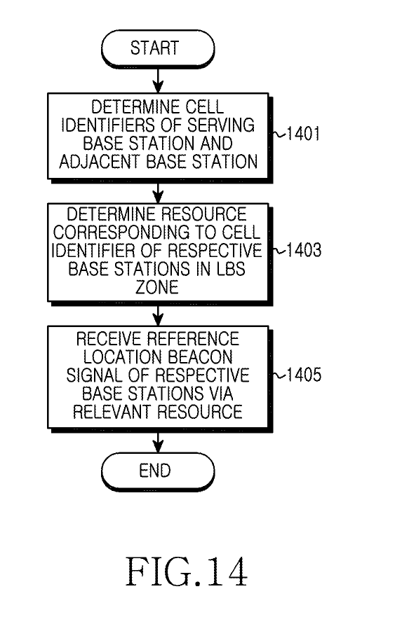

FIG. 14 is a flowchart illustrating a procedure for receiving a reference signal at a terminal according to an exemplary embodiment of the present invention.

Referring to FIG. 14, the terminal determines cell identifiers of a serving base station and adjacent base stations in step 1401. Here, when the base station has a plurality of segments, a cell identifier for each of the plurality of segments may be determined using equations 1 and 2.

The terminal determines a time-frequency resource corresponding to respective base stations in an LBS zone using a cell identifier of the respective base stations in step 1403. At this point, respective segments included in the respective base stations are not discriminated but may be allocated the same resource.

The terminal receives a reference location beacon signal from each base station via a time-frequency resource for the each base station within the LBS zone in step 1405. At this point, the terminal receives the same signal from respective segments included in the each base station.

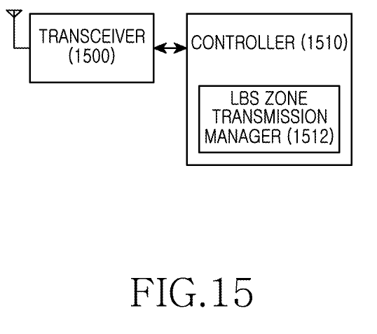

FIG. 15 is a schematic block diagram illustrating a base station according to an exemplary embodiment of the present invention.

Referring to FIG. 15, the base station includes a transceiver 1500 and a controller 1510. The controller 1510 includes an LBS zone transmission manager 1512.

The transceiver 1500 processes a signal transmitted/received to/from a terminal under control of the controller 1510. More particularly, the transceiver 1500 transmits a reference location beacon signal to a terminal via a resource corresponding to a cell identifier of the base station in an LBS zone.

The controller 1510 controls and processes an overall operation of the base station. In an exemplary embodiment of the present invention, the controller 1510 determines a cell identifier of the base station, and determines a time-frequency resource corresponding to the cell identifier in the LBS zone determined in advance to control and process a function for transmitting a reference location beacon signal to the relevant time-frequency resource by including the LBS zone transmission manager 1512. Here, the controller 1510 may determine a cell identifier for the respective plurality of segments using equations 1 and 2. At this point, the plurality of segments are not discriminated but may be allocated the same resource, and may transmit the same signal via the allocated same resource.

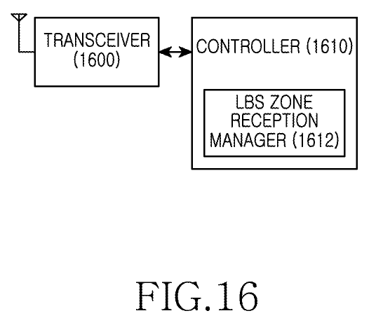

FIG. 16 is a schematic block diagram illustrating a terminal according to an exemplary embodiment of the present invention.

Referring to FIG. 16, the terminal includes a transceiver 1600 and a controller 1610. The controller 1610 includes an LBS zone reception manager 1612.

The transceiver 1600 processes a signal transmitted/received to/from a base station under control of the controller 1610. More particularly, the transceiver 1600 receives a reference location beacon signal from a serving base station and an adjacent base station in an LBS zone determined in advance, and provides the same to the controller 1510.

The controller 1610 controls and processes an overall operation of the terminal In an exemplary embodiment of the present invention, the controller 1610 determines cell identifiers of a serving base station and an adjacent base station, and determines a time-frequency resource corresponding to the cell identifiers of the base stations in the LBS zone determined in advance to control and process a function for receiving a reference location beacon signal in a relevant time-frequency resource by including the LBS zone reception manager 1612. Here, the controller 1610 may determine a cell identifier for the respective plurality of segments included in the respective base stations using equations 1 and 2. At this point, the plurality of segments included in one base station are not discriminated but may be allocated the same resource, and may transmit the same signal via the allocated same resource.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of a base station for transmitting a reference location beacon signal in a mobile communication system, the method comprising:
determining a cell identifier of a plurality of segments included in the base station;
determining a resource allocated to the plurality of segments using the cell identifier in a preset Location Based Service (LBS) zone; and
transmitting a reference location beacon signal via the determined resource,
wherein the plurality of segments being allocated the same resource and transmitting the same signal.

2. The method of claim 1, wherein the preset LBS zone is divided into a preset number of time-frequency resources, and respective divided time-frequency resources are allocated to different adjacent cells.

3. The method of claim 1, wherein the preset LBS zone is configured using at least one Orthogonal Frequency Division Multiplexing (OFDM) symbol during a preset number of super frames.

4. The method of claim 3, wherein the OFDM symbol configuring the LBS zone is repeated every preset period.

5. The method of claim 1, further comprising:
transmitting information of a super frame at which the preset LBS zone is located to a terminal.

6. A method of a terminal for receiving a reference location beacon signal in a mobile communication system, the method comprising:
determining a cell identifier of a plurality of segments included in at least two base stations in which signals are received;
determining a resource allocated to the plurality of segments included in each of the at least two base stations using the cell identifier in a preset Location Based Service (LBS) zone; and
receiving a reference location beacon signal from the at least two base stations via the determined resource,
wherein the plurality of segments being allocated the same resource and transmitting the same signal.

7. The method of claim 6, wherein the preset LBS zone is divided into a preset number of time-frequency resources, and respective divided time-frequency resources are allocated to different adjacent cells.

8. The method of claim 6, wherein the preset LBS zone is configured using at least one Orthogonal Frequency Division Multiplexing (OFDM) symbol during a preset number of super frames.

9. The method of claim 8, wherein the OFDM symbol configuring the LBS zone is repeated every preset period.

10. The method of claim 6, further comprising receiving information of a super frame at which the preset LBS is located from a base station.

11. An apparatus of a base station for transmitting a reference location beacon signal in a mobile communication system, the apparatus comprising:
a controller for determining a cell identifier of a plurality of segments included in the base station, and determining a resource allocated to the plurality of segments using the cell identifier in a preset Location Based Service (LBS) zone; and
a transmitter for transmitting a reference location beacon signal to a terminal via the determined resource,
wherein the plurality of segments being allocated the same resource and transmitting the same signal.

12. The apparatus of claim 11, wherein the preset LBS zone is divided into a preset number of time-frequency resources, and respective divided time-frequency resources are allocated to different adjacent cells.

13. The apparatus of claim 11, wherein the preset LBS zone is configured using at least one Orthogonal Frequency Division Multiplexing (OFDM) symbol during a preset number of super frames.

14. The apparatus of claim 13, wherein the OFDM symbol configuring the LBS zone is repeated every preset period.

15. The apparatus of claim 11, wherein the transmitter transmits information of a super frame at which the preset LBS zone is located to the terminal.

16. An apparatus of a terminal for receiving a reference location beacon signal in a mobile communication system, the apparatus comprising:
a controller for determining a cell identifier of a plurality of segments included in at least two base stations in which signals are received, and determining a resource allocated to the plurality of segments included in each of the at least two base stations using the cell identifier in a preset Location Based Service (LBS) zone; and
a receiver for receiving a reference location beacon signal from the at least two base stations via the determined resource,
wherein the plurality of segments being allocated the same resource and transmitting the same signal.

17. The apparatus of claim 16, wherein the preset LBS zone is divided into a preset number of time-frequency resources, and respective divided time-frequency resources are allocated to different adjacent cells.

18. The apparatus of claim 16, wherein the preset LBS zone is configured using at least one Orthogonal Frequency Division Multiplexing (OFDM) symbol during a preset number of super frames.

19. The apparatus of claim 18, wherein the OFDM symbol configuring the LBS zone is repeated every preset period.

20. The apparatus of claim 16, wherein the receiver receives information of a super frame at which the preset LBS zone is located from a base station.
